(19) United States
(12) Patent Application Publication
(10) Pub. No.: US 2025/0336116 A1
(43) Pub. Date: Oct. 30, 2025

(54) Interactive Network for Selecting, Ranking, Summarizing, and Exploring Data Insights

(71) Applicant: Adobe Inc., San Jose, CA (US)

(72) Inventors: Jane Elizabeth Hoffswell, Seattle, WA (US); Wei Zhang, Great Falls, VA (US); Victor Soares bursztyn, Redwood City, CA (US); Shunan Guo, San Jose, CA (US); Prithvi Bhutani, Lynnwood, WA (US); Jesse Martinez, Seattle, WA (US); Eunyee Koh, San Jose, CA (US); Abhisek Trivedi, South Jordan, UT (US)

(73) Assignee: Adobe Inc., San Jose, CA (US)

(21) Appl. No.: 18/649,468

(22) Filed: Apr. 29, 2024

(51) Int. Cl. G06T 11/20; G06F 40/40

(52) U.S. Cl. CPC G06T 11/206; G06F 40/40; G06T 2200/24

(57) ABSTRACT

Insight summary and prompt generation techniques are described. In one or more examples, a plurality of insights is generated from data extracted from digital content. A network representation is produced having a plurality of nodes based on the plurality of insights and a plurality of connections between corresponding insights. A selection is received of a subset of nodes from the plurality of nodes. A prompt is formed by grouping respective insights from the subset of nodes. An insight summary of the digital content is generated based on the prompt using generative artificial intelligence as implemented using one or more machine-learning models. The insight summary is then presented for output in a user interface.

### BACKGROUND

Dataset size and the availability of different types of data within the dataset continues to expand. As a result, data analytics that are employed to interpret a dataset face ever increasing technical challenges in how to interpret this data. Conventional data analytics techniques, for instance, are confronted with a variety of data sources involving individualized access, balancing of complications caused by access to “too much” information with a loss of potentially valuable information, lack of specialized knowledge usable to interpret that data, and so forth.

Although conventional techniques have been developed to employ machine learning as an automated aid to this analysis, these conventional techniques have failed to provide sufficient amounts of accuracy in real-world scenarios. These inaccuracies result in inefficient use of computational resources and user frustration caused by failure of the conventional techniques to operate for the intended purpose.

### SUMMARY

Insight summary and prompt generation techniques are described. In one or more examples, a plurality of insights is generated from data extracted from digital content. A network representation is produced having a plurality of nodes based on the plurality of insights and a plurality of connections between corresponding insights. A selection is received of a subset of nodes from the plurality of nodes. A prompt is formed by grouping respective insights from the subset of nodes. An insight summary of the digital content is generated based on the prompt using generative artificial intelligence as implemented using one or more machine-learning models. The insight summary is then presented for output in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ insight summary and prompt generation techniques described herein.

FIG. 2 depicts a system in an example implementation showing operation of a data insight system of FIG. 1 in greater detail.

FIG. 3 depicts a system in an example implementation showing operation of an insight connection module of FIG. 2 in greater detail.

FIG. 4 depicts a system in an example implementation showing operation of a summary generation module of FIG. 2 in greater detail.

FIG. 5 depicts an example implementation of a digital dashboard formed using a plurality of items configured as subpanels that include text and digital images.

FIG. 6 depicts an example implementation of a prompt formed from a subset of the selected insights from a network representation.

FIG. 7 depicts an example implementation of a network visualization panel as supporting output of an insight summary.

FIG. 8 depicts another example implementation of a network visualization panel as supporting output of an insight summary.

FIG. 9 depicts an example implementation of a story exploration panel as supporting output of the insight summary.

FIG. 10 depicts an example implementation of a summary browser panel as supporting output of the insight summary.

FIG. 11 is a flow diagram depicting an algorithm as a step-by-step procedure in an example implementation of operations performable for accomplishing a result of insight summary generation.

FIG. 12 is a flow diagram depicting an algorithm as a step-by-step procedure in an example implementation of operations performable for accomplishing a result of insight summary generation through interaction with a display of a network representation in a user interface.

FIG. 13 illustrates an example system including various components of an example device that can be implemented as any type of computing device as described and/or utilize with reference to the previous figures to implement embodiments of the techniques described herein.

### DETAILED DESCRIPTION

### Overview

Automated summary generation is a technique used to increase an ability to interpret a dataset. However, real-world scenarios introduce numerous technical challenges. Examples of technical challenges include size of the dataset, how data is expressed across various datasets, dataset access, balancing of complications caused by access to “too much” information with a loss of potentially valuable information, lack of specialized knowledge usable to interpret that data, and so forth.

Accordingly, insight summary and prompt generation techniques are described that address these and other technical challenges. A digital insight system, for instance, is executable to receive a source dataset as an input. The source dataset is displayable as digital content in a user interface. An example of digital content includes a digital dashboard that operates as an analysis tool to compare and analyze data which may include text and digital images as visualizations usable to represent underlying meaning and trends identified from the source dataset. Digital dashboards, while configured to convey a variety of data, are often difficult to interpret and involve specialized knowledge in order to identify trends and causation represented by the source dataset.

Therefore, in the techniques described herein the data insight system is configured to generate an insight summary based on the digital content, e.g., as displayed in a user interface such as the digital dashboard example above as a source dataset. These techniques are configured to overcome technical challenges as experienced by conventional automated summary generation techniques that often fail to surface information regarding entities and omit potentially valuable information.

To do so, the data insight system generates a prompt using a network representation that defines connections between insights collected from a source dataset. The prompt is then used as an input to a machine-learning model (e.g., a large language model, a diffusion-based model, and so on) to generate an insight summary that strikes a balance between generating a natural-sounding summary as well as a factually complete summary. As a result, the insight summary has increased accuracy over conventional techniques in a readily consumable form by an entity without specialized knowledge.

In one or more examples, a data insight system receives a source dataset, e.g., a digital dashboard displayed in a user interface. The data insight system generates insights by extracting data from the source dataset. Examples of data extraction include extracting metadata and text from the source dataset, use of a machine-learning model to process a digital image (e.g., a data visualization) to generate an insight as a caption, and so forth.

The data insight system then forms insight connections between the insights. Examples of insight connections include layout-based connections, type-based connections, topic-based connections, temporal-based connections, score-based connections, and so forth. The insights and insight connections are then used as a basis by the data insight system for form a network representation (e.g., as a graph) that includes nodes corresponding to the insights as connected using the formed connections.

In one or more examples, a ranking of nodes and connections within the network representation is then usable to form a prompt. The nodes and connections between the nodes of the network representation, for instance, are usable by the data insight system to form a ranking, e.g., based on a number of connections, types of connections, and so forth. In one or more examples, the ranking is based on a weighting of types of connections exhibited by respective connections associated with the nodes. The data insight system then utilizes the network representation to select a threshold number of nodes (e.g., a top ten percent) as a subset from the network representation. Insights corresponding to the subset are then used as a basis to form a prompt, e.g., as ordered based on correspondence with respective items from the source dataset according to the ranking. The prompt, for instance, is formed as one or more paragraphs of text formed from the insights accordingly to the ranking and correspondence with the items from the digital dashboard.

The prompt is then used as an input to a machine-learning model (e.g., an LLM, a diffusion-based model, etc.) to generate an insight summary. In this way, the insight summary provides context to respective items from the digital dashboard in this example based on connections identified between the insights, which is not possible using conventional techniques.

The data insight system is further configurable to leverage the network representation in support of additional functionality. An option, for instance, is displayable in the user interface to “Tell Me More.” Selection of the option causes generation of a request to initiation selection of additional nodes by the data insight system from the network representation (e.g., based on a second threshold amount of fifteen percent) which are then used to generate a prompt, and from the prompt, an insight summary. As a result, the data insight system supports an ability to “drill down” to obtain additional information from the source dataset (e.g., the digital dashboard) as desired. Additional examples are also contemplated.

The data insight system, in one or more additional examples, also supports an interactive user interface for insight exploration. For example, the data insight system is configurable to support a network visualization panel that includes an interactive network visualization of the network data that depicts the nodes and connections between the nodes. Inputs received via the user interface are configurable to select an individual node and/or collections of nodes that are to be used to generate the insight summary non-modally and in real time in the user interface to serve as a basis to form the prompt as described above.

In another example, a story exploration panel (i.e., a linear story panel) is supported by the data insight system that is usable to review selected insights and accompanying visualization. A summary browser panel is also supported to explore automatically generated and user-selected sets of insights. In this way, the data insight system addresses technical challenges of conventional systems to generate the insight summary with increased accuracy, automatically and without user intervention. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

A “diffusion-based model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Insight Summary and Prompt Generation Environment

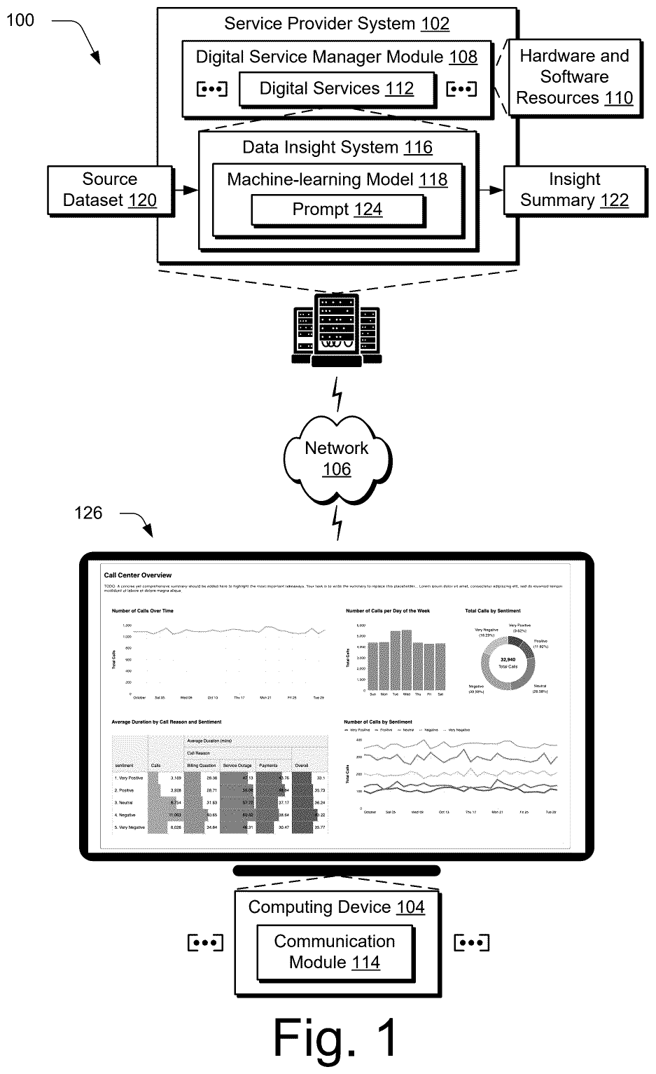

FIG. 1 is an illustration of a digital medium environment 100 in an example implementation that is operable to employ insight summary and prompt generation techniques described herein. The illustrated environment 100 includes a service provider system 102 and a computing device 104 that are communicatively coupled, one to another, via a network 106. Computing devices are configurable in a variety of ways.

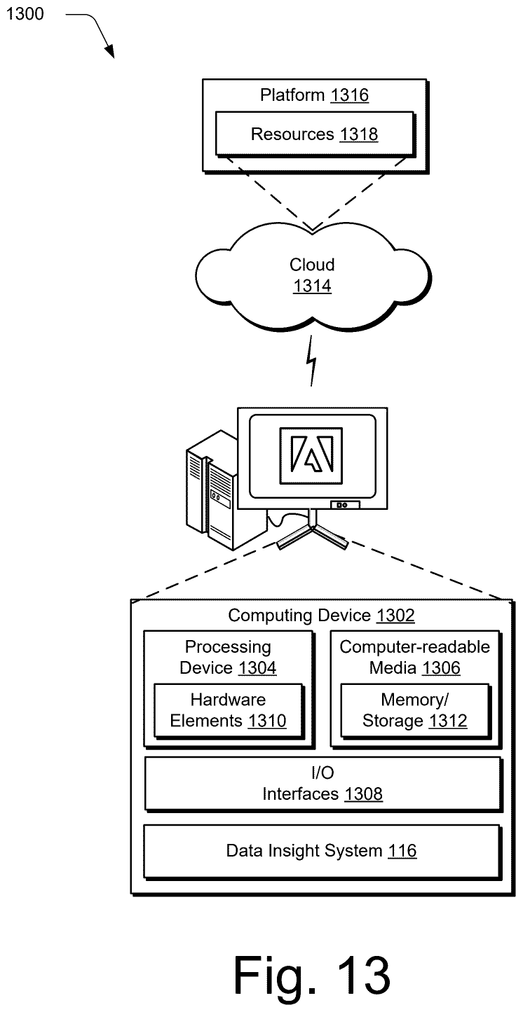

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 13.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on.

Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a data insight system 116. Although illustrated as implemented remotely at the service provider system 102, the data insight system 116 is also configurable for local execution, e.g., at the computing device 104. The data insight system 116 includes at least one machine-learning model 118 in the illustrated example to process a source dataset 120 to generate an insight summary 122. To do so, the data insight system 116 generates a prompt 124 from the source dataset 120 that increases accuracy of the at least one machine-learning model 118 in generating the insight summary 122 when compared with conventional techniques.

The data insight system 116, for instance, supports generation of a network representation from the source dataset 120 as a dense representation of different types of connections between related insights. The data insight system 116 also supports selection, ordering, and prompt generation from a selected set of insights from the network representation. The data insight system 116 further supports a visualization system in support of user exploration and customized selection of a set of related insights. As a result, the data insight system 116 addresses inaccuracies of conventional techniques that are solely based on processing of the source dataset in its entirety and/or are agnostic to a relationship of insights from within the source dataset.

The data insight system 116, for instance, supports generation of a network representation having nodes describing insights generated from the source dataset 120 and connections of insights represented by the nodes. The network representation is configurable to support user navigation between passages, e.g., a specific insight or category of insights. A variety of connections are definable between the insights. In a first example, layout-based connections define how a digital dashboard 126 informs relationships between insights. In a second example, topic-based connections leverage how underlying dimensions and metrics impact insight relationships. In a third example, type-based connections rely on how a type of insight relates to other insights generated for a same digital dashboard 126. Temporal-based connections involve an example in which insights are naturally ordered based on corresponding temporal value references in the source dataset 120. In a fifth example, score-based connections leverage user preferences, compound metrics, and so forth as a gauge of impact of the “correctness” of multiple insights. In an implementation, the network representation includes nodes that reference corresponding insights as well as categorization nodes that act as gatekeepers and organizational aides to facilitate subsequent exploration as further described below.

The data insight system 116 is also configurable to leverage the network representation as part of generating the prompt 124 for processing by the at least one machine-learning model 118. The data insight system 116, for instance, is configured to rank the nodes and connections of the network representation based on corresponding insights, connections, weights applied to particular types of connections, and so forth. For example, the data insight system 116 is configurable to rank insights based on values of score-based connections alone, rank insights based on a weighted combination of score-based connections (e.g., a weight of seventy percent) and layout-based connections, e.g., with a weight of thirty percent.

Once the insights are ranked, the data insight system 116 selects a threshold number (e.g., top “K” insights), which are then used to form groups based on correspondence with respective items from the source dataset 120. Insights related to a top-left visualization of the digital dashboard 126 are grouped together, for instance, followed by insights from a top-right visualization, and so on. The insights, therefore, are grouped according to the ranking and then text from the insights is concatenated into corresponding paragraphs to form the prompt 124.

The prompt 124 is then processed by the at least one machine-learning model 118, e.g., an LLM, a diffusion-based model, etc. The LLM, for instance, is configurable to decode the next “n” tokens, e.g., defined as seventy percent of a total number of tokens of the curated insights, with a decoding temperature “T” set near zero (e.g., 0.3) to minimize hallucination as part of generating the insight summary 122.

The data insight system 116 is configurable to employ a variety of considerations in support of generating the insight summary 122. The digital dashboard 126, for instance, includes multiple items (e.g., subpanels) configured as tables and other visualizations. In one or more implementations, for each column (e.g., metric) in each subpanel, the data insight system 116 is configurable to generate summaries of the insights as part of generating the insight summary 122.

For each insight, for instance, the data insight system 116 records relevant properties (e.g., reference data values and insight type) and pairs these properties with metadata from the source dataset 120, e.g., a panel position with respect to a layout of the digital dashboard 126 and information about the underlying visualization type. This information is then usable by the data insight system 116 to compute compound scores to define an amount each of the insights are related to each other and generate connections (e.g., links) between the insights to form the network representation. Using these scores and links, the data insight system 116 selects insights to create the insight summary 122, which is displayable as part of the network representation in a user interface.

The data insight system 116 is configurable to employ a variety of visualization techniques and functionalities as part of presenting the insight summary 122 for display in a user interface, e.g., as part of generating text using the LLM, a digital image using a diffusion-based model, generation of visualizations using a templated-based approach and metadata from a source dataset, and so forth. The insight summary 122, for instance, is configurable to employ a network visualization panel that guides user interaction through selection of narrative components (i.e., insights) using a graph display of the network representation. In another instance, the data insight system 116 is configured to generate the insight summary 122 as a linear story panel that displays a current summary and individual story components along with corresponding visualizations. The data insight system 116 also supports configuration of the insight summary 122 as part of a summary compilation panel that enables user navigation between saved and pre-generated insight summaries. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Prompt and Insight Summary Generation

The following discussion describes prompt and insight summary generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

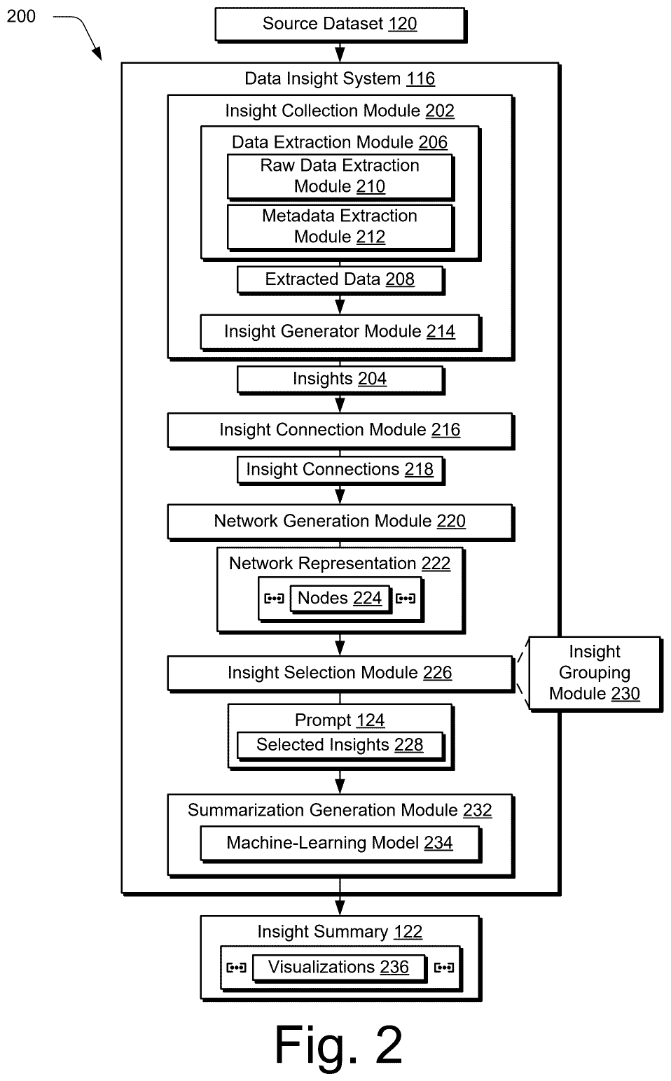

FIG. 2 depicts a system 200 in an example implementation showing operation of the data insight system 116 of FIG. 1 in greater detail. The data insight system 116 begins by receiving a source dataset 120. The source dataset 120 is configurable in a variety of ways. In one or more examples, the source dataset 120 is configured for display in a user interface, such as a digital dashboard as previously described.

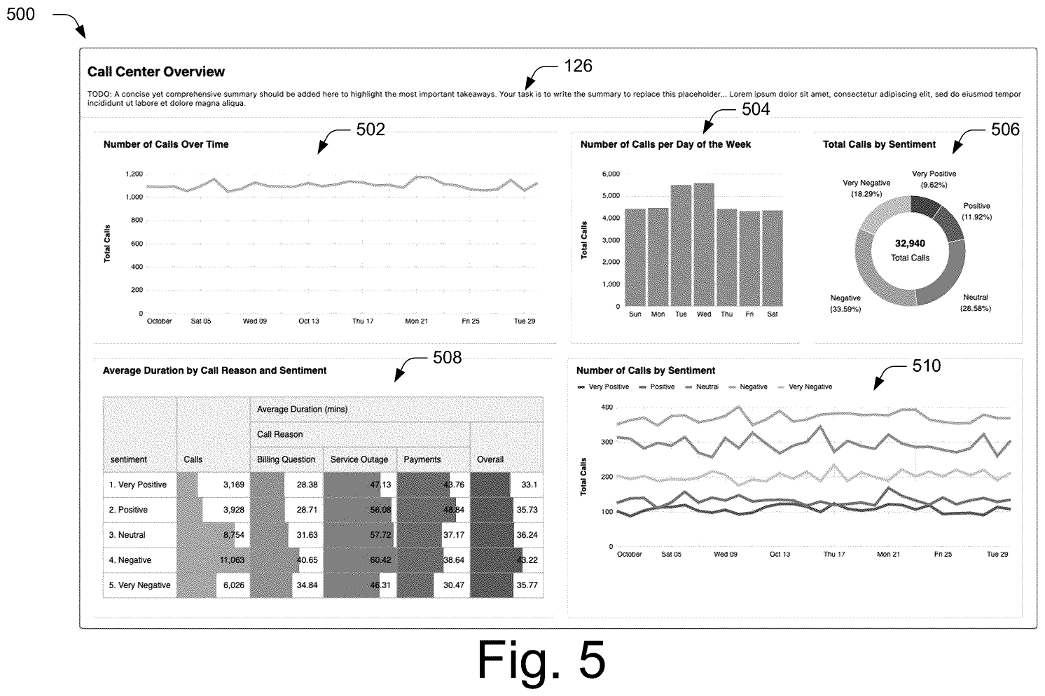

FIG. 5 depicts an example implementation 500 of a digital dashboard 126 formed using a plurality of items configured as subpanels that include text and digital images, e.g., as visualizations using tables, charts, graphics, and so forth. The digital dashboard 126 includes a line chart 502 showing a number of calls per date, a bar chart 504 of a number of calls per day of the week, a donut chart 506 of a number of calls by sentiment, a table 508 showing an average call duration by call reason, and a multi-line chart 510 of a number of calls by sentiment per date.

The data insight system 116 begins processing of the source dataset 120 through use of an insight collection module 202 to generate insights 204. To do so in the illustrated example, the insight collection module 202 includes a data extraction module 206 to extract data from the source data 120, which is illustrated as extracted data 208. The insight collection module 202, for instance, includes a raw data extraction module 210 to extract text included in the source dataset 120, e.g., from titles, captions, and so forth. The data extraction module 206 also includes a metadata extraction module 212 to extract metadata from the source dataset 120, e.g., relative positions of the portions, timestamps, display characteristics, formatting information, and so forth.

The insight collection module 202 also includes an insight generation module 214 that is configured to generate insights based on the source dataset 120, e.g., from the extracted data 208. The insights, for instance are generated based on an underly data and visualization type. In additional instances, the extracted data 208 may include one or more digital images as visualizations. Accordingly, the insight generation module 214 is configurable to employ a machine-learning model configured to employ caption-generation functionality to generate a caption as a text description of a respective digital image. The insight generation module 214, for instance, is configured to employ a convolutional neural network (CNN) to extract image features from a respective digital image. The extracted image features are then communicated as an input to a Long Short-Term Memory (LSTM) model, which is a type of recurrent neural network, to generate a text description based on the features to form a respective insight 204. The insights 204 (e.g., extracted text, metadata, captions, etc.) are then passed to an insight connection module 216 to identify connections between the insights, which is represented as insight connections 218 in the figure.

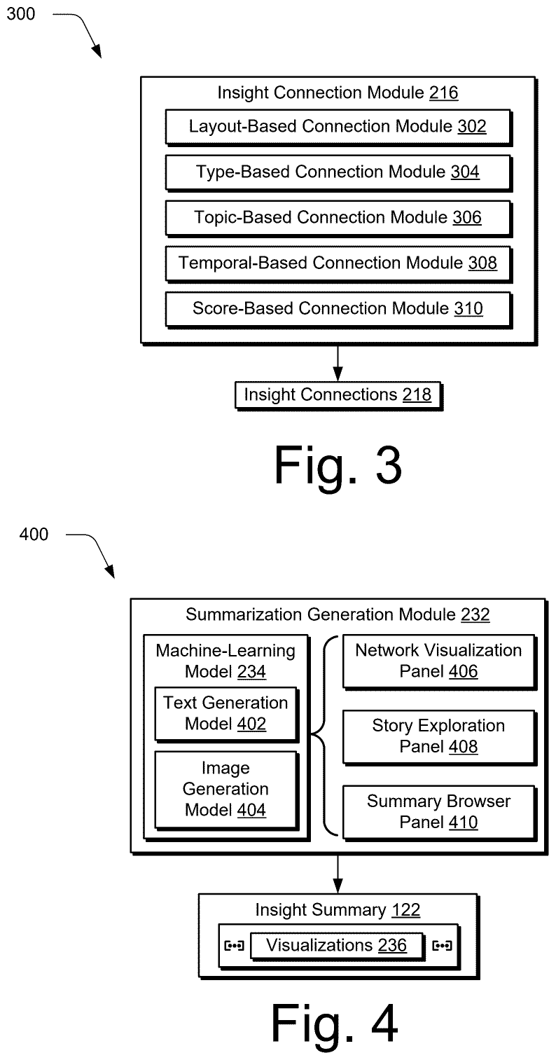

FIG. 3 depicts a system 300 in an example implementation showing operation of the insight connection module 216 of FIG. 2 in greater detail. Given a set of insights 204 automatically generated (e.g., for visualizations or tables in the digital dashboard 126) by the insight collection module 202, the insight connection module 216 identifies five types of connections (e.g., categories) that are indicative of whether an insight is related (e.g., directly) to another insight.

A variety of connections are definable between the insights. In a first example, a layout-based connection module 302 is configured to identify layout-based connections that define how a digital dashboard 126 informs relationships between insights. In a second example, a type-based connection module 304 is configured to identify type-based connections that relate how a type of insight relates to other insights generated for a same digital dashboard 126.

In a third example, a topic-based connection module 306 is configured to identify topic-based connections that leverage how underlying dimensions and metrics impact insight relationships. In a fourth example, a temporal-based connection module 308 is configured to identify temporal-based connections that are leveraged to control how insights can be naturally ordered based on corresponding temporal value references in the source dataset 120. In a fifth example, a score-based connection module 310 is configured to generate score-based connections that leverage user preferences, compound metrics, and so forth as a gauge of impact of the “correctness” of multiple insights.

The layout-based connection module 302, for instance, is configured to leverage a layout of the digital dashboard 126 as an insight into intent of a creator of the digital dashboard 126. For example, items (e.g., sub-panels) located higher in the digital dashboard 126 may indicate that the corresponding information has a greater important or involves frequent access than other items in the user interface. In another example, a layout within a table may indicate priority and/or the evolution of calculated metrics, e.g., often in reading-order.

Accordingly, the layout-based connection module 302 is configured to address a variety of layout-related information for identifying a layout-based connection, examples of which include: (1) panel position, e.g., row and column of the sub-panel in the digital dashboard 126; (2) table position, e.g., the row and column of a dimension or metric in an underlying table; (3) sort status, e.g., a column corresponding to the insight is sorted, rather than another column in the table; and (4) redundant encodings, e.g., multiple sub-panels correspond to same underlying data, such as both a visualization and table. The insight connection module 216 is configurable to then form a clustering of insights using layout-based connections that mirrors an initial layout of the digital dashboard 126 in order to generate the network representation as further described below.

The topic-based connection module 306 is configured to identify a topic-based connection as a particular dimension or metric that may occur within multiple sub-panels of a dashboard, thereby suggesting that the topic is of particular interest to the dashboard-creator. While there may be some overlap with the layout-based connections, topic-based connections are usable to directly co-locate related insights that occur at different locations throughout the digital dashboard 126. Topic-based connections are also usable to consider other features of the source dataset 120, such as filters or segments. In the digital dashboard 126 of FIG. 5, subheadings are used to breakdown a dimension.

The type-based connection module 304 is configured to identify a type-based connection as another form of connection that is independent of layout and topic. For example, a focus may be given to analyzing spikes that occur in the data, regardless of which topic or sub-panel include the spikes.

The temporal-based connection module 308 is implemented to identify temporal-based connections that are usable to provide an intuitive ordering to the insights and thus denote another form of connection that is independent from the layout, insight-type, and topic categories above. While singular date/time references are straightforward to cluster as part of forming a network representation as further described below, a notable complexity arises when working with both singular and ranged values.

The score-based connection module 310 is configured to calculate score-based connections between insights. The previous categories relate to intrinsic properties of the insights and may thus do not support general-purpose explorations of the data in some scenarios, e.g., to surface the five “most important” insights. To support this form of exploration, the score-based connection module 310 supports a category of score-based connections, e.g., compound connections. For example, a score may be specified for each insight that combines a priority from the layout-based connection (e.g., position, sorting, etc.) with a measure of prevalence of the insights, e.g., an amount of times the values mentioned in the insight compared to each of the other insights.

A weighted “priority” score, for instance, may be defined as:

score=0.3*layoutScore+0.7*valueScore

which gives a higher weight to the mentioned values compared to the overall layout. The “layoutScore” can be computed as follows:

layoutScore=0.25*panelRow+0.25*panelCol+0.35*tableCol+0.15*isSorted.

The “panelRow,” “panelCol,” and “tableCol” scores are computed as:

1−x/max(x)

where “x” is either a panel row index, panel column index, or table column index for the insight and “max(x)” is a maximum value for the entire digital dashboard 126. Next, the score-based connection module 310 computes the “valueScore” as follows:
(1) count the occurrences for all nominal values or dates across all of the generated insights; AND
(2) for each insight, compute the average occurrence as “avgOcc=1/n*Σvᵢ−1.” where “vᵢ” is the count of the value or date and “n” is the number of unique values or dates mentioned in the insight; and
(3) compute the “valueScore” by adjusting the “avgOcc” for the insight based on the min or max for each of the insights in the digital dashboard 126:

valueScore=(vScore−min(vScore))/(max(vScore)−min(vScore)).

The score-based links are extendable to cover a variety of unique formula or combination of other scores. A variety of other examples of connections are also contemplated.

Returning back again to FIG. 2, the insight connections 218 are then passed as an input to a network generation module 220. The network generation module 220 is configured to generate a network representation 222 having nodes 224 that correspond to the insights 204. The nodes 224 are connected within the network representation 222 based on the insight connections 218. In this way, the network representation 222 provides a representation of interrelations between insights from the source dataset 120 and digital dashboard 126 and thus is usable to form a ranking of nodes and connections with the network representation.

In an implementation, the network representation 222 is extended through use of “gatekeeping nodes.” The large variety of connections and corresponding insights support a variety of ways to explore the source dataset 120. However, determining which type of links that may be of interest remains difficult. To address this technical challenge, the network generation module 220 is configured to support a flexible exploration environment as part of generating the network representation 222 through addition of gatekeeping nodes for each insight-type, topic, and score available in the network representation 222.

The gatekeeping nodes, for instance, are configurable to support specific types of connections, which are usable to dictate when certain links for the given insight node are surfaced. The network generation module 220 is configured to create a topic node for each data column (i.e., metric). The network generation module 220 further adds one topic node for each item's (e.g., sub-panel's) dimension. The network generation module 220 additionally creates extra nodes for sub-panels that include a segment-level breakdown, i.e., a second dimension. Finally, additional nodes are further usable to group the insights (and topics) by the higher-level topic.

The network representation 222 is then passed as an input to an insight selection module 226 that is configured to select a subset of the nodes 224 as selected insights 228 that are usable as a prompt 124 for generating the insight summary 122. The nodes and connections between the nodes 224 of the network representation 222, for instance, are usable by the insight selection module 226 to form a ranking, e.g., based on a number of connections, types of connections, and so forth.

The insight selection module 226 then utilizes the network representation 222 to select a threshold number of nodes 224 (e.g., a top ten percent) as a subset from the network representation. Insights corresponding to the subset are then used as a basis to form the prompt 124, e.g., as ordered based on correspondence with respective items from the source dataset according to the ranking. In another example, the selection is made based on an input received via a user interface that selects particular nodes to form the subset as further described below in relation to the network visualization panel.

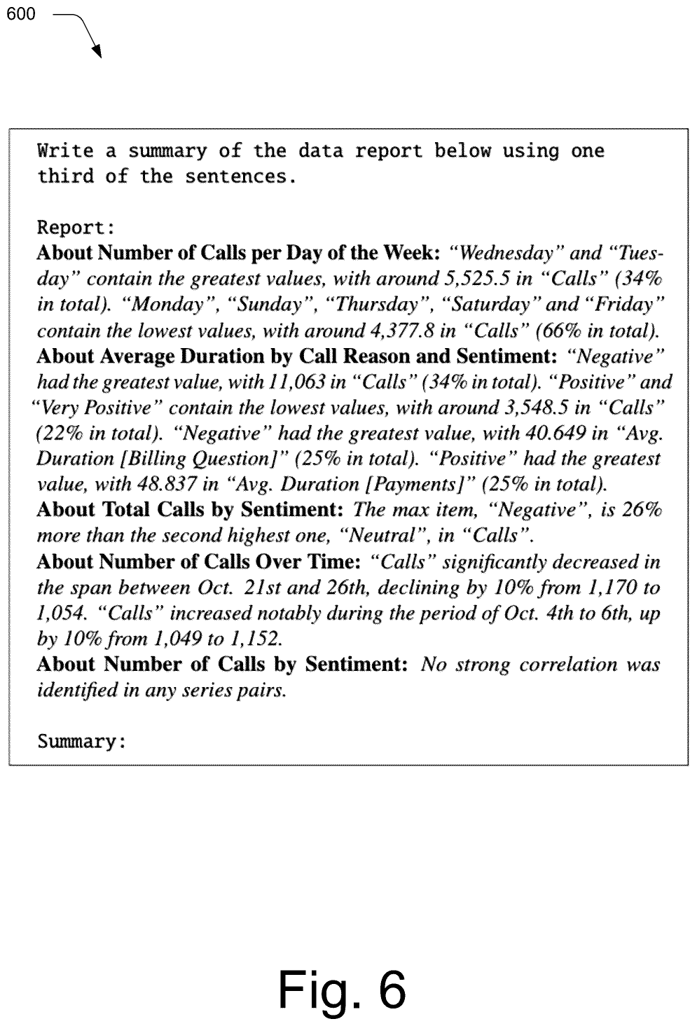

FIG. 6 depicts an example implementation 600 of a prompt 124 formed from a subset of a selected insights 228 from a network representation 222. The insight selection module 226 employs an insight grouping module 230 that is configured to group insights that correspond to respective items (e.g., sub-panels, portions) of the digital dashboard 126 of FIG. 5. The grouped insights are then ordered based on rankings, e.g., as assigned to respective nodes 224 and/or insight connections 218 in the network representation 222. In this way, the prompt 124 includes a ranked and grouped ordering of text describing insights that are then usable as a basis to form the insight summary 122.

The prompt 124 is then received as an input by a summarization generation module 232 that employs one or more machine-learning models 234 to generate an insight summary 122. The one or more machine-learning models 234, for instance, are configurable as a large language model that is configured to generate the insight summary 122 based on the prompt 124 using abstractive summarization. To do so, the LLM employs natural language understanding to identify key points, themes, and context. Semantic analysis is then employed by the LLM to analyze semantics of text of the prompt 124 to generate the insight summary 122 as an abstraction, while employing functionality to ensure coherence and fluency in the result.

The summarization generation module 232 also supports an ability to expand exploration of the network representation 222 through use of additional insights 204 as prompts to form the insight summary 122. An option, for instance, is displayable in the user interface to “Tell Me More.” Selection of the option causes selection of additional nodes by the insight selection module 226 from the network representation 222 (e.g., based on a second threshold amount of fifteen percent) which are then used to generate a prompt 124, and from the prompt 124, an insight summary 122 by the one or more machine-learning models 234 of the summarization generation module 232. As a result, the data insight system 116 supports an ability to “drill down” to obtain additional information from the source dataset (e.g., the digital dashboard) as desired. Additional examples are also contemplated.

The summarization generation module 232 is also configurable to generate one or more visualizations 236, e.g., using a template-based approach leverage metadata from a source dataset, using the one or more machine-learning models 234 such as a diffusion-based model, and so forth. As previously described, a diffusion-based model is a type of generative machine-learning model that is used for digital content creation, e.g., digital images. In order to train a diffusion-based model, noise is added to training data samples until the data within the training data samples is obscured. The diffusion-based model is then trained to reverse this process based on training data that also has a text prompt that describes the digital content to be created in order to generate data samples as the digital content that corresponds to the text prompt. As a result, text of the prompt 124 is further usable to generate one or more visualizations 236 as part of the insight summary 122.

Thus, the example above begins with a digital dashboard 126 containing multiple items, e.g., sub-panels having tables and visualizations. For each column (e.g., metric) for each item, an insight generation module 214 is configured to generate captions as insights 204. For each insight 204, the insight collection module 202 is configurable to record corresponding properties (e.g., referenced data values and insight type) and pair this information with metadata from the digital dashboard 126, e.g., the panel position in the layout and information about the underlying visualization type. This information is then used by the data insight system 116 to (1) compute scores indicative of a corresponding amount of relatedness of the insights, one to another, and (2) generate connections between insights. Using these scores and connections, the insight selection module 226 is configured to automatically select a subset of insights as prompts 124 to create different summaries using one or more machine-learning models 234 of the summarization generation module 232.

FIG. 4 depicts a system 400 in an example implementation showing operation of the summary generation module 232 of FIG. 2 in greater detail. The summary generation module 232 employs one or more machine-learning models 234 that support generation of the insight summary 122, e.g., a text generation module 402 (e.g., an LLM), an image generation model 404 (e.g., a diffusion-based model), and so on. By leveraging the machine-learning models 234, the summary generation module 232 is configured to support a variety of types of user interface configurations. Example of user interface configurations include (1) a network visualization panel 406 configured to guide user selection of narrative components (i.e., insights); (2) a story exploration panel 408 that displays the current summary and the individual story components (with the corresponding visualization); and (3) a summary browser panel 410 that enables the user to browse both saved and pre-generated summaries.

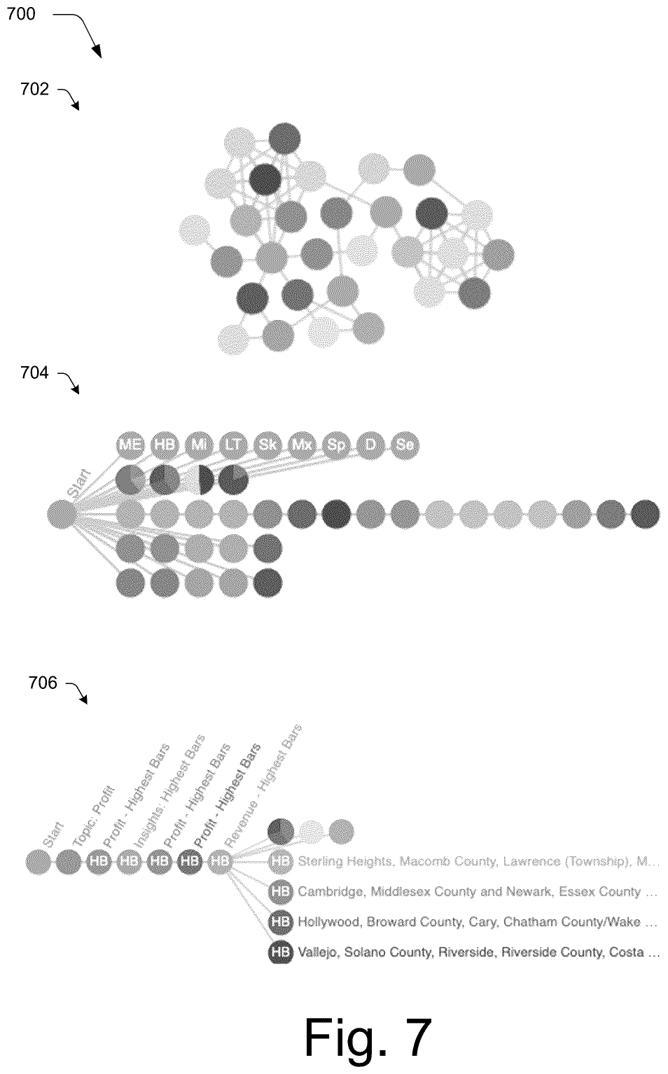

FIG. 7 depicts an example implementation 700 of a network visualization panel 406 as supporting output of the insight summary 122. To increase organization as part of a browsing experience, a graph layout of the insight summary 122 is shown for exploring the neighboring nodes in the network representation 222. To begin at a first instance 702, gatekeeping nodes are organized based on type. At a second instance 704, type nodes are shown in the top row and ordered by the number of underlying insights and compound topic nodes are shown in the second row and also ordered by the insight count. Topic nodes are organized by panel and column position in the following rows, and time-based and score-based nodes are similarly arranged by the strength of the connections, e.g., used as a basis for a ranking.

Upon receipt of a user selection via a user interface, if there are five or fewer nodes, the nodes are arranged vertically and include a long label to facilitate selection as shown at a third instance 706. This threshold is user customizable. Other layouts are also supported to arrange nodes based on the particular emphasis of the user, e.g., if user interest is expressed for a particular topic, the layout promotes the topic first and other characteristics second.

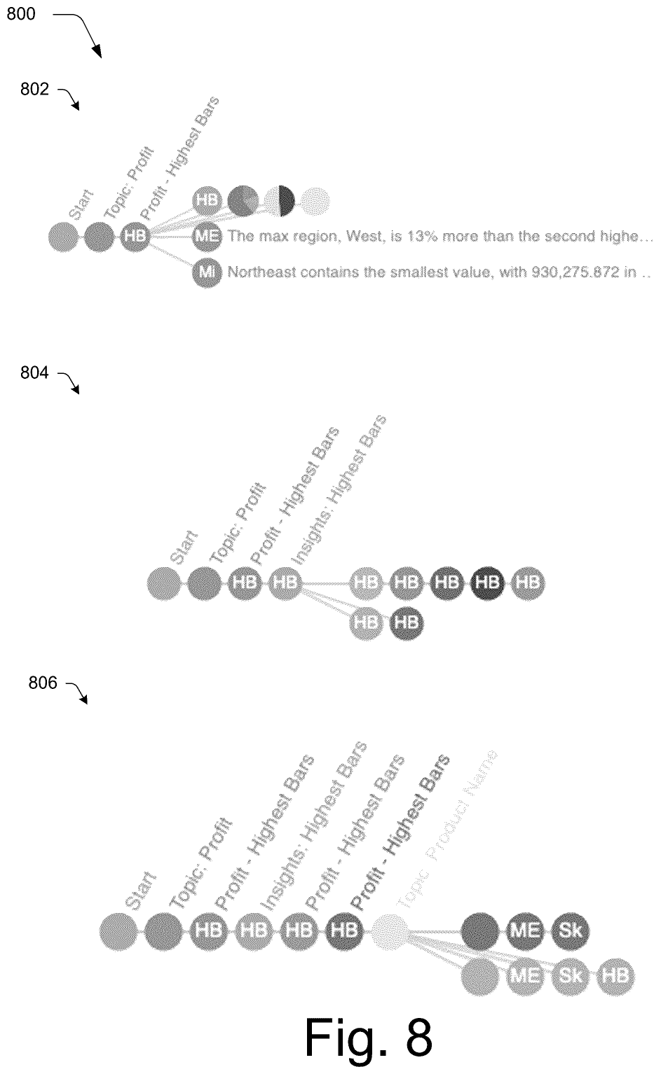

FIG. 8 depicts another example implementation 800 of a network visualization panel 406 as supporting output of the insight summary 122. At a first instance 802, a first row of nodes depicts related categories of topics that support exploration via the user interface. For example, the first row supports surfacing of other insights about “Highest Bars,” general insights for “profit” and “region,” and so forth.

At a second instance 804, insight-based connections are illustrated depicting insights related to “highest bars” for other visualization panels in the digital dashboard 126. At a third instance 806, topic based connections are illustrated as related to a product name for both “Profit” and “Revenue.”

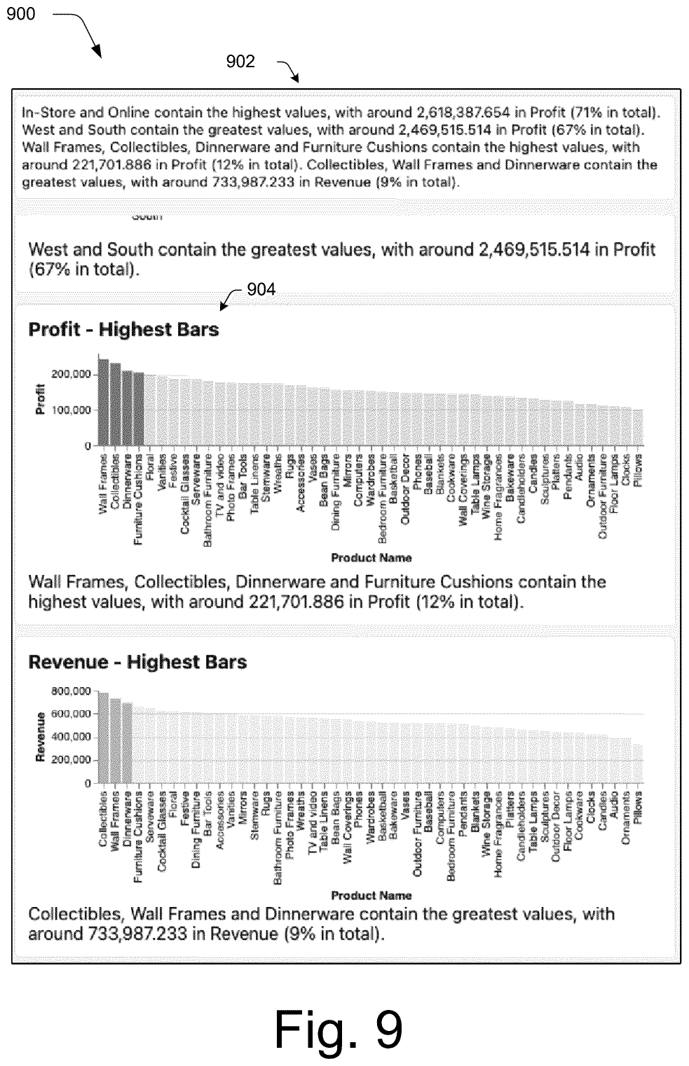

FIG. 9 depicts an example implementation 900 of a story exploration panel 408 as supporting output of the insight summary 122. The story exploration panel has two primary components: (1) a concise summary paragraph 902 and (2) an expanded narrative containing the individual story components 904.

Upon receipt of a selection via the user interface of node from the network representation, the text of the insight is appended to the summary paragraph 902 and the story components 904 (e.g., containing the title, insight text, and representative visualization) is appended to the expanded narrative. To create the visualizations, predefined chart templates are leveraged based on a chart-type originally specified for each sub-panel in the digital dashboard 126. Highlights may also be included to indicate values mentioned in the insight. For example, selection of an insight node corresponding to the “Revenue: Highest Bars HB” causes the insight to be appended as a last sentence of the summary.

Upon hovering a cursor over a narrative component, for instance, options are supported to delete or reorder from the history, which also updates the top level summary. Toggling is also supported to control whether previous steps in the narrative are shown using a “Show/Hide Prev” button. Hiding the previous steps supports output of the narrative component for a recent node, solely, whereas when a full narrative is shown, the story exploration panel is automatically scrolled (e.g., to the bottom) to show a most recent component.

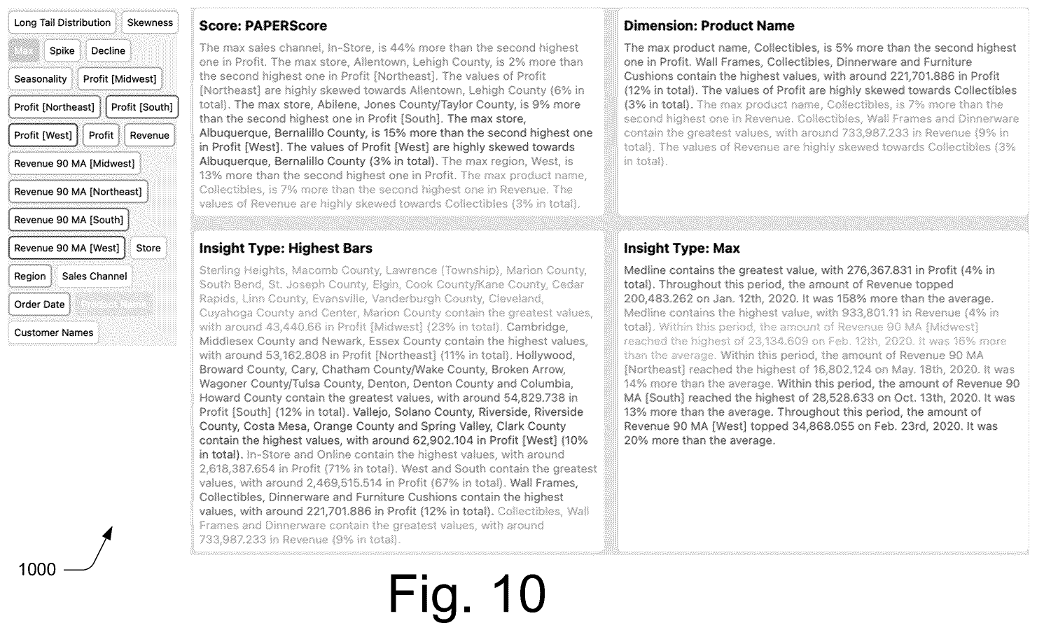

FIG. 10 depicts an example implementation 1000 of a summary browser panel 410 as supporting output of the insight summary 122. The summary browser panel is configured to display both automatically created insight summary 122 (e.g., based on the different types of links rep resented in the network representation 222) as well as any user-specified summaries that have been saved in the user interface. Interactive tags are also supported to filter which summaries and insights are shown. The interactive tags, for instance, support a three-way toggle: (1) “on” shows both the summaries defined for this tag and the underlying insights; (2) “partial” shows the underlying insights for the tag but not the summary blocks; and (3) “off” shows neither the underlying insights nor the summary blocks. The toggles are leveraged to filter categories of insights from display.

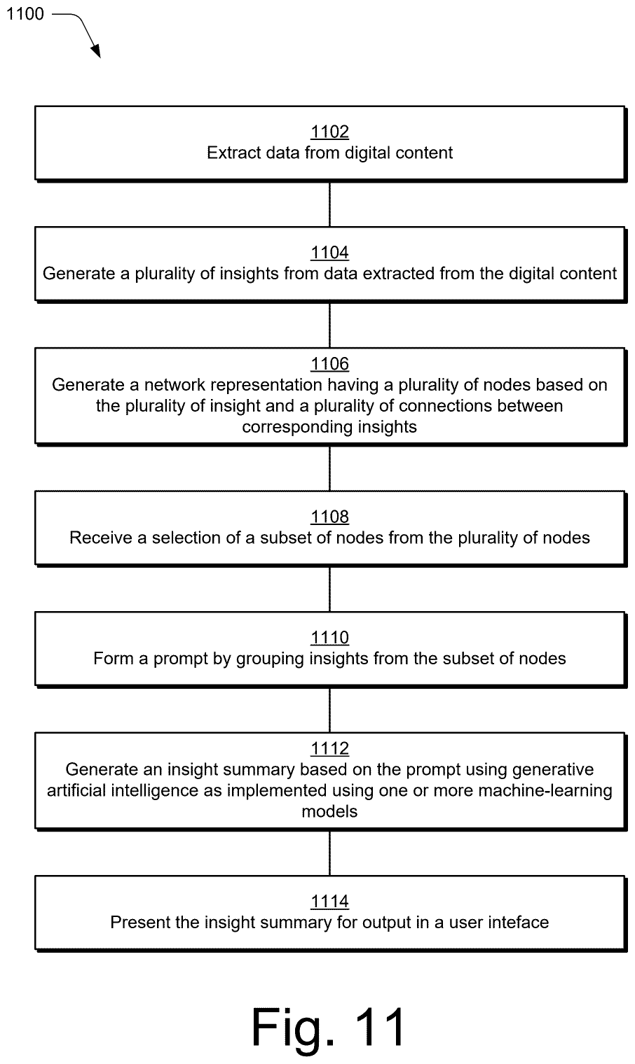

FIG. 11 is a flow diagram depicting an algorithm 1100 as a step-by-step procedure in an example implementation of operations performable for accomplishing a result of insight summary generation. To begin in this example, data is extracted from digital content (block 1102). A plurality of insights are generated from data extracted from digital content (block 1104). A network representation is produced having a plurality of nodes based on the plurality of insights and a plurality of connections between corresponding insights (block 1106). A selection is received of a subset of nodes from the plurality of nodes (block 1108). A prompt is formed by grouping respective insights from the subset of nodes (block 1110). An insight summary of the digital content is generated based on the prompt using generative artificial intelligence as implemented using one or more machine-learning models (block 1112). The insight summary is presented for output in a user interface (block 1114).

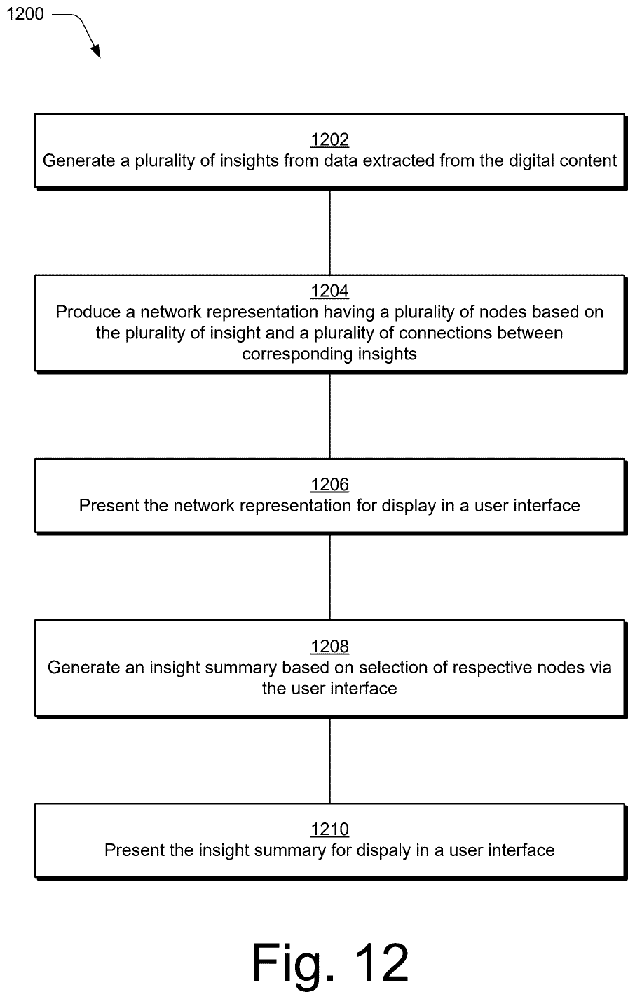

FIG. 12 is a flow diagram depicting an algorithm 1200 as a step-by-step procedure in an example implementation of operations performable for accomplishing a result of insight summary generation through interaction with a display of a network representation in a user interface. A plurality of insights is generated from data extracted from a digital dashboard displayed in a user interface (block 1202). A network representation is produced as a graph having a plurality of nodes based on the plurality of insights and a plurality of connections between corresponding insights (block 1204). The network representation is presented for display in a user interface (block 1206). An insight summary is generated based on selection of respective nodes via the user interface. The insight summary is generated using generative artificial intelligence as implemented using one or more machine-learning models using one or more insights corresponding to the respective nodes as a prompt (block 1208). The insight summary is presented for display in the user interface (block 1210).

### Example System and Device

FIG. 13 illustrates an example system generally at 1400 that includes an example computing device 1302 that is representative of one or more computing systems and/or devices that implement the various techniques described herein.

This is illustrated through inclusion of the data insight system 116. The computing device 1302 is configurable, for example, as a server of a service provider, a device associated with a client (e.g., a client device), an on-chip system, and/or any other suitable computing device or computing system.

The example computing device 1302 as illustrated includes a processing device 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1304 is representative of functionality to perform one or more operations using hardware. Accordingly, the processing device 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1306 is illustrated as including memory/storage 1312 that stores instructions that are executable to cause the processing device 1304 to perform operations. The computer-readable storage medium is configured for storing instructions that, responsive to execution by the processing device, causes the processing device to perform operations. The memory/storage 1312 represents memory/storage capacity associated with one or more computer-readable media. The memory/storage 1312 includes volatile media (such as random access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing device 1304. The instructions and/or functions are executable/operable by one or more articles of manufacture (for example, one or more computing devices 1302 and/or processing devices 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1414 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to encountered demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

In implementations, the platform 1316 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating, by a processing device, a plurality of insights from data extracted from digital content;
producing, by the processing device, a network representation having:
a plurality of nodes based on the plurality of insights; and
a plurality of connections between corresponding said insights;
receiving, by the processing device, a selection of a subset of nodes from the plurality of nodes;
forming, by the processing device, a prompt by grouping respective said insights from the subset of nodes;
generating, by the processing device, an insight summary of the digital content based on the prompt using generative artificial intelligence as implemented using one or more machine-learning models; and
presenting, by the processing device, the insight summary for output in a user interface.

2. The method as described in claim 1, wherein the digital content is a user interface configured as a digital dashboard including at least one digital image as a visualization.

3. The method as described in claim 2, wherein at least one said insight is generated based on the at least one digital image as a caption using a machine-learning model.

4. The method as described in claim 1, wherein the grouping is based, at least in part, by correspondence with respective items of a plurality of items that form the digital content.

5. The method as described in claim 1, wherein the connections include a layout-based connection, a type-based connection, a topic-based connection, a temporal-based connection, or a score-based connection.

6. The method as described in claim 1, wherein the selection is based on a ranking.

7. The method as described in in claim 6, wherein the ranking is based on weighting of types exhibited by respective said connections associated with the plurality of nodes.

8. The method as described in claim 1 wherein the selection is received via a user interface that includes output of the plurality of nodes and the selection selects the subset.

9. The method as described in claim 1, further comprising identifying, by the processing device, the plurality of connections between the corresponding said insights.

10. The method as described in claim 1, further comprising:
receiving a request to expand the insight summary;
selecting at least one additional node from the plurality of nodes, and
generating an expanded insight summary based on the subset and the at least one additional node.

11. A computing device comprising:
a processing device; and
a computer-readable storage medium storing instructions that, responsive to execution by the processing device, causes the processing device to perform operations including:
extracting data from a digital dashboard displayed in a user interface;
generating a plurality of insights as captions using at least one machine-learning model based on the extracted data;
producing a network representation having:
a plurality of nodes based on the plurality of insights; and
a plurality of connections between corresponding said insights; and
generating an insight summary of the digital dashboard based on a prompt using generative artificial intelligence as implemented using one or more machine-learning models, the prompt generated based on at least one said insight from a respective said node.

12. The computing device as described in claim 11, wherein at least one said insight is generated based on at least one digital image as a caption using a machine-learning model.

13. The computing device as described in claim 11, further comprising identifying, by the processing device, the plurality of connections between the corresponding said insights, wherein the plurality of connections includes a layout-based connection, a type-based connection, a topic-based connection, a temporal-based connection, or a score-based connection.

14. The computing device as described in claim 11, further comprising:
receiving a request to expand the insight summary;
selecting at least one additional node from the plurality of nodes, and
generating an expanded insight summary based on the respective said node and the at least one additional node.

15. One or more computer-readable storage media storing instructions that, responsive to execution by a processing device, causes the processing device to perform operations comprising:
generating a plurality of insights from data extracted from a digital dashboard displayed in a user interface;
producing a network representation as a graph having:
a plurality of nodes based on the plurality of insights; and
a plurality of connections between corresponding said insights;
presenting the network representation for display in a user interface;
generating an insight summary based on selection of respective said nodes via the user interface, the insight summary generated using generative artificial intelligence as implemented using one or more machine-learning models using one or more said insights corresponding to the respective said nodes as a prompt; and
presenting the insight summary for display in the user interface.

16. The one or more computer-readable storage media as described in claim 15, wherein at least one said insight is generated based on at least one digital image as a caption using a machine-learning model.

17. The one or more computer-readable storage media as described in claim 15, further comprising identifying, by the processing device, the plurality of connections between the corresponding said insights.

18. The one or more computer-readable storage media as described in claim 17, wherein the plurality of connections includes a layout-based connection, a type-based connection, a topic-based connection, a temporal-based connection, or a score-based connection.

19. The one or more computer-readable storage media as described in claim 15, further comprising:
receiving a request to expand the insight summary;
selecting at least one additional node from the plurality of nodes, and
generating an expanded insight summary based on the respective said nodes and the at least one additional node.

20. The one or more computer-readable storage media as described in claim 15, wherein the displaying of the insight summary is performed along with the respective said nodes.
